(19) United States
(12) Patent Application Publication
(10) Pub. No.: US 2024/0149357 A1
(43) Pub. Date: May 9, 2024

(54) Metal Drill

(71) Applicant: Robert Bosch GmbH, Stuttgart (DE)

(72) Inventor: Milan Bozic, Luterbach (CH)

(21) Appl. No.: 18/502,800

(22) Filed: Nov. 6, 2023

(30) Foreign Application Priority Data
Nov. 8, 2022 (DE) 10 2022 211 783.2

(51) Int. Cl. B23B 51/02

(52) U.S. Cl. CPC B23B 51/02; B23B 2224/24; B23B 2228/10

(57) ABSTRACT

A metal drill includes a cutting section and a drive section pointing away therefrom. The metal drill has at least two different functional coatings are provided which are designed at least in regions and are designed to permit machining of a metallic workpiece adapted to a respective application material. The drive section has, at least in sections, a polygonal, preferably hexagonal cross-sectional geometry.

This application claims priority under 35 U.S.C. § 119 to application no. DE 10 2022 211 783.2, filed on Nov. 8, 2022 in Germany, the disclosure of which is incorporated herein by reference in its entirety.

### BACKGROUND

The disclosure relates to a metal drill having a cutting section and a drive section extending therefrom.

Twist drills are generally known from the prior art.

For example, WO 2019/147885 A1 shows a twist drill having a first end with a drill point and a second end directed away therefrom. An axis of rotation extends centrally from the first end to the second end through a base body of the drill. A shaft is provided in the region of the second end for rotatably driving the drill by a tool, such as a hand tool, a pillar drill, or the like. The drill bit has a plurality of axially progressive steps receding toward the shaft or second end, including a first step and a final step. A radial diameter of the stages increases from the first stage to the final stage, the final stage having a diameter less than or equal to an outer diameter of the base body.

### SUMMARY

The present disclosure relates to a metal drill having a cutting section and a drive section extending therefrom. At least two different and at least regionally formed functional coatings are designed to enable machining of a metallic workpiece adapted to a respective application material, the drive section having at least in sections a polygonal, preferably hexagonal cross-sectional geometry.

This allows a wide range of different metallic workpieces to be machined quickly and easily with the metal drill. In addition, a long service life of the metal drill is given. The at least two functional coatings of the metal drill are preferably designed without overlap. In the context of the description, the term functional coatings defines not only the application of at least one additional functional layer to the surface of the metal drill, at least in some regions. Rather, the term functional coating is also intended here to comprise the penetration or diffusion of the chemical substances used for this purpose into a near-surface edge zone of up to 5 μm, preferably in a range of 1 μm to 2 μm, of the metal drill and/or a chemical-physical transformation of the near-surface edge zone of the metal drill. Such a chemical-physical transformation of the near-surface edge zone takes place, for example, during so-called carburizing or burnishing to form black oxide.

A large number of metal drills, each with at least two different and at least regionally designed functional coatings, can be combined in a storage unit in order to be able to address an even broader range of applications and to further optimize handling. The storage unit may also include at least one metal drill that is free of any functional coating. The storage unit may be in the form of a mobile and preferably resealable hard or soft case and may have metal drills of different diameters in a suitable gradation. In addition, a product presentation unit appealing to prospective buyers, in which metal drills provided with functional coatings and metal drills without coatings are combined, can be provided for use in stationary retail.

Preferably, the at least two functional coatings are designed to increase a surface hardness of the metal drill.

As a result, the feed rate as well as the service life of the metal drill increases considerably. In addition to increasing the hardness of the surface layer, the functional coatings can also have other functions, such as reducing friction. The functional coatings of the metal drills allow optimal machining of workpieces designed with an application material such as steel, iron, cast iron, stainless steel, titanium, aluminum, copper, lead, etc., as well as metal alloys.

Preferably, a first functional coating of the at least two functional coatings is formed with titanium nitride and a second functional coating of the at least two functional coatings is formed with aluminum titanium nitride.

Alternatively or in addition, a variety of other functional coatings are possible to increase the hardness of the surface layer. Titanium nitride enables a hardness of 2300±300 HV 0.5, while with aluminum titanium nitride a hardness of 2500±500 HV 0.5 can be achieved. In comparison, an uncoated metal drill is in a hardness range <1000 HV 0.5. The functional coatings can be applied over the entire surface, in any geometric pattern in certain regions and, if necessary, overlapping each other at least in certain regions.

In a technically advantageous further development, the cutting section has a cutting head with two cutting edges and a guide section is preferably designed between the cutting section and the drive section.

This provides an effective drilling process due to improved guidance of the metal drill in the workpiece to be machined with the aid of the cylindrical guide section. The guide and drive sections preferably together form the shaft of the metal drill.

Preferably, the cutting section has two spiral flutes.

This allows chips produced during drilling to be discharged and a coolant and lubricant to be easily supplied if required. Each of the two flutes preferably has a ground guide chamfer directed radially outward. The guide chamfers also reduce the friction between the metal drill and the workpiece to be machined.

Preferably, the metal drill has an approximately constant diameter at least in the region of the cutting head and the cutting section.

As a result, high dimensional accuracy of the holes produced in the workpiece being machined is ensured.

Preferably, the cutting head is designed in the manner of a cone shell ground or a surface ground.

This allows conventional manufacturing processes to be used and proven cutting geometries to be realized. Preferably, the cutting head of the metal drill is designed according to DIN 1412:2001-03 Form C.

Preferably, the metal drill is formed with a high-speed steel.

Due to the temperature resistance provided by this, a high feed rate is possible with nevertheless low wear.

According to a technically advantageous embodiment, the drive section and the cutting section are roll-rolled, forged, and/or at least partially machined from solid.

As a result, common manufacturing processes can be used to produce the metal drill, with roller burnishing in particular offering particular cost advantages.

According to a technically advantageous embodiment, a metal drill is identified by a unique marking that identifies a metallic workpiece to be machined with the metal drill.

A single or multi-colored marking allows a user to clearly and easily select the most suitable metal drill for drilling a workpiece formed with a particular application material. The marking can comprise geometric surface elements, any characters (letters and numbers) and/or graphics, pictograms as well as combinations thereof, from which the suitability of the metal drill for a metallic workpiece to be machined is immediately apparent to the user. Alternatively, an indirect assignment of a marking that is not immediately “self-explanatory” can be made by means of an external table, a (smartphone) app, or the like. The marking can be machine-readable for this purpose, for example as an optical barcode, QR code, or the like. In this case, for example, a plain text name of an application material to be processed in the best possible way with the metal drill in question can be output using the (smartphone) app. The external table or marking may also be associated with an optional storage unit for a plurality of metal drills according to the disclosure. For example, accommodation spaces of the storage unit for one metal drill each can be provided with a corresponding marking. In addition or alternatively, the marking can be designed to be haptically perceived by a user.

### BRIEF DESCRIPTION OF THE DRAWINGS

The disclosure is explained in further detail in the following description with reference to exemplary embodiments shown in the drawings. Shown are:

FIG. 1 a side view of a metal drill,

FIG. 2 an enlarged side and top view of the cutting head of the metal drill of FIG. 1, with a cone shell ground,

FIG. 3 an enlarged side and top view of the metal drill of FIG. 1, with a surface ground, and

FIG. 4 a schematic view of a drilling system with four metal drills, each with two different coatings, and an optional uncoated metal drill for use on various metallic workpieces.

### DETAILED DESCRIPTION

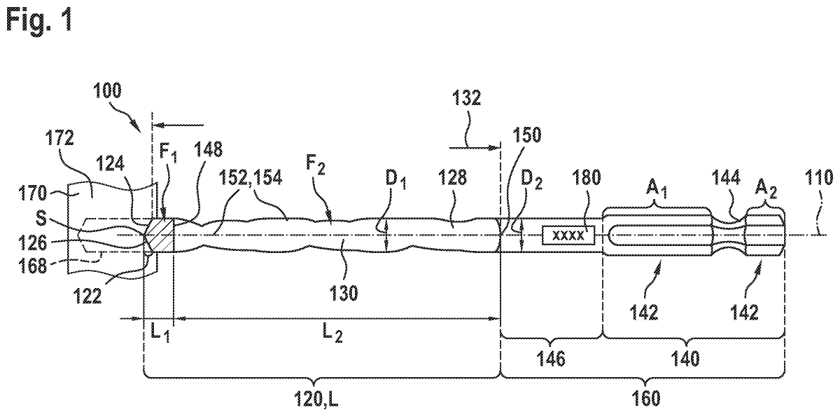

FIG. 1 shows a metal drill 100 having a cutting section 120 and a drive section 140 directed axially away therefrom. These are preferably designed to be rotationally symmetrical with respect to a longitudinal central axis 110.

The cutting section 120 has a cutting head 122 with a (drill) tip S, the cutting head 122 being adjoined by a flute section 132 pointing in the direction of the drive section 140 and having, by way of example, two flutes 128, 130 spirally coiled around one another. Illustratively, the cutting head 122 has two cutting edges 124, 126 oriented radially outwardly from the tip S for machining a hole 168 in a metallic workpiece 170 formed with an application material 172.

The flute 128 has a ground guide chamfer 152 and the flute 130 has a corresponding ground guide chamfer 154.

A cylindrical guide section 146 extends between the cutting section 120 and the drive section 140. This is preferably also designed to be rotationally symmetrical to the longitudinal center axis 110. At least in the region of the cutting head 122 and the cutting section 120, the metal drill 100 preferably has an approximately constant diameter D₁, which here essentially corresponds to a diameter D₂ of the guide section 146. The guide section 146, together with the drive section 140, forms a shaft section 160 of the metal drill 100.

The drive section 140 of the metal drill 100 has, at least in sections, a polygonal cross-sectional geometry 142 that is merely hexagonal by way of example here. This preferably has two axial sections A_{1,2}, between which a fillet-like annular groove 142 extends. In principle, the drive section 140 can have any regular or irregular polygonal cross-sectional geometry that provides a form-fit connection with a tool holding of a tool that rotationally drives the metal drill 100, such as a hand drill or a pillar drill.

In the region of the cutting section 120 of the metal drill 100, a first functional coating F₁ and a second functional coating F₂ are provided, wherein the functional coatings F_{1,2} butt against each other here only exemplarily, forming a first boundary line 148. Illustratively, the first functional coating F₁ extends from the tip S of the metal drill 100 to the boundary line 148 over an axial length L₁, while the second functional coating F₂ extends from the boundary line 148 to a second boundary line 150 and has an axial length of L₂. The second boundary line 150 is between the cutting section 120 and the shaft section 160 of the metal drill 100, which is uncoated in this example. Both boundary lines 148, 150 have the form of a circular line here as an example. The sum of the axial lengths L_{1,2} of the functional coatings F_{1,2} corresponds here only by way of example to an overall length L of the cutting section 120, but may also deviate from the overall length.

The length L₁ of the first functional coating F₁ is preferably smaller than the length L, so that there always remains an axial circumferential area, albeit a small one, for forming the second functional coating F₂ with the axial length L₂. In addition, the shaft section 160 may also be provided with the first and/or the second functional coating F_{1,2}, as appropriate. Among other things, this can reduce any wear in the region of the guide section 146 of the metal drill 100 when making deep holes in the metallic workpiece 170. The boundary lines 148, 150 can have a course deviating from the circular line shape and, for example, be rectangular, triangular, or sinusoidal, so that the functional coatings F_{1,2} are interlocked with one another, in particular in the region of the first boundary line 148, or engage in one another in the manner of interlocking without overlapping. Nevertheless, an overlapping formation of the functional coatings F_{1,2} is possible.

In principle, the at least two functional coatings F_{1,2} can be designed in any pattern on the metal drill 100. For example, a pattern in the form of continuous or interrupted axial longitudinal stripes running essentially parallel to the longitudinal center axis 110 is conceivable, with the functional coatings F₁ and F₂ alternating on the circumferential side in each case. As a result, the different physical properties of the functional coatings F_{1,2} can be used in close spatial proximity. Accordingly, for example, a spiral formation of the functional coatings F_{1,2} analogous to the course of the flutes 128, 130 of the metal drill is also possible.

The functional coatings F_{1,2} are preferably designed to increase the surface hardness of the metal drill 100 in a region near the surface of the cutting section 120 of the metal drill 100, but may also have friction-reducing or other functions. The first functional coating F₁ can be realized with titanium nitride, for example, and the second functional coating F₂ can be realized with aluminum titanium nitride, for example, wherein the aluminum titanium nitride can be provided with additives. Other possible material combinations for forming the first and second functional coatings F_{1,2} include, for example, titanium carbon nitride, titanium aluminum carbon nitride, chromium carbon nitride, zirconium nitride, titanium aluminum nitride, aluminum chromium nitride, aluminum titanium chromium nitride, aluminum titanium nitride-zirconium carbon nitride, tungsten carbide-carbon, aluminum nitrate silicon, and aluminum titanium nitride.

At least the cutting section 120 of the metal drill 100 is preferably designed with a high-speed steel (HSS). The cutting section 120 and the drive section 140 may be roll-rolled, forged, and/or at least partially machined from solid. The cutting section 120 and the drive section 140 may be integral or joined together in a suitable manner, which may be by friction welding, thermal shrinking, compression molding, or the like.

Preferably, the metal drill 100 has a unique marking 180 in the region of the guide section 146 that identifies a metallic workpiece 170 to be optimally machined with the present metal drill 100 that is designed with the application material 172. Due to the marking 180, the user can intuitively select a metal drill for machining that is best suited in each case. The marking 180 may comprise geometric area elements, any characters (letters and numbers) and/or graphics, pictograms, and combinations thereof. In the illustration of FIG. 1, the marking 180 is implemented only exemplarily with the four capital letters “X”. Deviating from the illustration of FIG. 1, the marking can also be implemented in the region of the drive section 140.

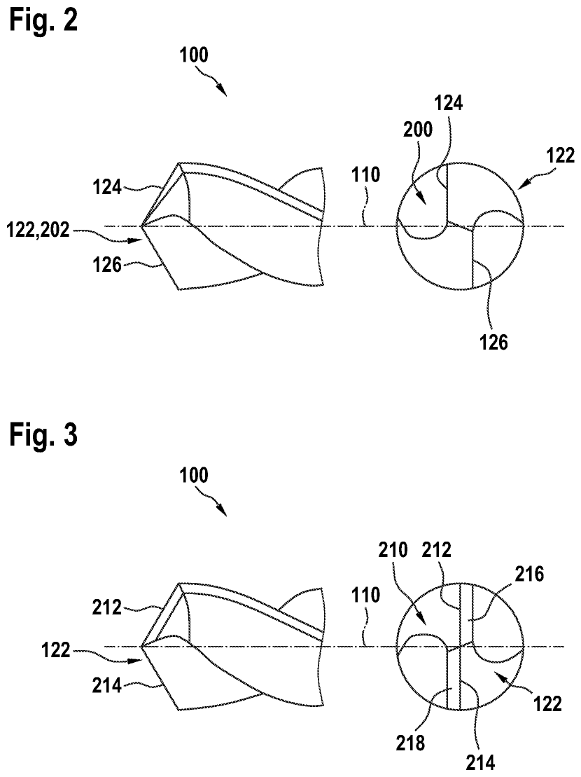

FIG. 2 shows the cutting head 122 of the metal drill 100 of FIG. 1, which is designed here in exemplary rotational symmetry with respect to the longitudinal center axis 110 and is ground illustratively in the manner of the standard cone shell ground 200. As a result, the two cutting edges 124, 126 are formed and a front surface 202 of the cutting head 122 forms an approximately cone-shaped enveloping surface.

FIG. 3 shows the cutting head 122 of the metal drill 100 of FIG. 1, which here, by way of example, is designed rotationally symmetrical to the longitudinal center axis 110 and, in contrast to the representation of FIG. 2, is ground illustratively in the manner of the so-called surface ground 210. This forms two cutting edges 212, 214. Due to the surface ground 210, two approximately trapezoidal planar surfaces 216, 218 are created, wherein the cutting edge 212 forms a longitudinal side of the planar surface 216 and the cutting edge 214 forms a longitudinal side of the planar surface 218.

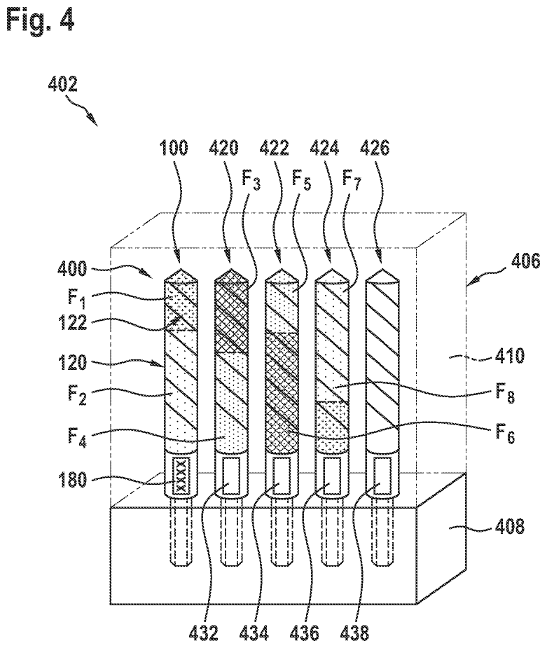

FIG. 4 shows an exemplary drilling system 400, which here merely exemplifies a total of five metal drills 100, 420, 422, 424, 426 that are combined or housed in a storage unit 402 for convenient use by the user. The metal drills 100, 420, 422, 424, 426 each preferably in turn have a hexagonal drive section that is not designated for the sake of a better drawing overview.

Illustratively, the metal drill 100 has the functional coating F₁ in the region of its cutting head 122 and the functional coating F₂ in the remaining region of the cutting section 120 (see in particular FIG. 1). Deviating therefrom, the metal drill 420 has exemplary functional coatings F_{3,4}, the metal drill 422 has exemplary functional coatings F5,6, and the metal drill 424 has exemplary functional coatings F_{7,8}, while the metal drill 426 has exemplary design without coating.

The area proportions of the functional coatings F_{3, . . . , 8} in the region of the cutting sections of the metal drills 420, 422, 424 may differ from those of the metal drill 100 as shown. Each of the coated metal drills 100, 420, 422, 424 preferably has at least two or more functional coatings F_{1, . . . , 8} designed at least in some regions, at least in the region of its respective cutting section.

The functional coatings F_{3, . . . , 8}, for example, are realized with other chemical compounds or substances compared to the first and second functional coating F_{1,2} and consequently have other physical parameters such as (micro-)hardness HV 0.5 according to Vickers, maximum permissible application temperature, coefficient of friction against 100Cr6 steel, or the like. Thus, each of the differently coated metal drills 100, 420, 422, 424 as well as the metal drill 426 without coating is particularly suitable for drilling a metallic workpiece made of a special application material such as steel, iron, cast iron, stainless steel, titanium, aluminum, copper, lead, etc., as well as metal alloys.

Due to the marking 180 of the metal drill 100 and the corresponding markings 432, 434, 436, 438 of the metal drills 420, 422, 424 as well as 426, an unambiguous selectability of the metal drill 100, 420, 422, 424, 426 best suited for the machining of a given metallic workpiece made of a certain application material by the user for achieving best possible working results is ensured. In order to permit particularly easy and convenient access by the user to the differently coated metal drills 100, 420, 422, 424 as well as the metal drill 426 without coating, these are preferably combined in a storage unit 402 in the form of a hard case 406 shown here only by way of example. In this example, the hard case 406 has a cuboid bottom portion 408 for holding the metal drills 100, 420, 422, 424, 426 and a transparent top portion 410. Instead of the hard case 406, a case-like or pocket-like soft case or other storage unit, such as a revolver magazine-like or cylindrical or cassette-like storage unit, may also be provided.

1. A metal drill comprising:
a cutting section;
a drive section directed away from the cutting section, the drive section having, in at least one section, a polygonal cross-sectional geometry; and
at least two different functional coatings formed at least in regions, the at least two functional coatings being configured to permit machining of a metallic workpiece in a manner adapted to a respective application material.

2. The metal drill according to claim 1, wherein the at least two functional coatings are designed to increase a surface hardness of the metal drill.

3. The metal drill according to claim 1, wherein a first functional coating of the at least two functional coatings is formed with titanium nitride and a second functional coating of the at least two functional coatings is formed with aluminum titanium nitride.

4. The metal drill according to claim 1, wherein the cutting section has a cutting head with two cutting edges and a guide section is arranged between the cutting section and the drive section.

5. The metal drill according to claim 4, wherein the cutting section has two helical flutes.

6. The metal drill according to claim 4, wherein the metal drill has an approximately constant diameter at least in a region of the cutting head and the cutting section.

7. The metal drill according to claim 4, wherein the cutting head is configured as a cone shell ground or a surface ground.

8. The metal drill according to claim 1, wherein the metal drill is formed of a high-speed steel.

9. The metal drill according to claim 1, wherein the drive section and the cutting section are roll-rolled, forged, and/or at least partially machined from solid.

10. The metal drill according to claim 1, further comprising a unique marking identifying a metallic workpiece the metal drill is configured to machine.

11. The metal drill according to claim 1, wherein the at least one section of the drive section has a hexagonal cross-sectional geometry.
